(19) United States
(12) Patent Application Publication
(10) Pub. No.: US 2026/0077382 A1
(43) Pub. Date: Mar. 19, 2026

(54) PIERCING NOZZLE WITH RETENTION FEATURE

(71) Applicant: Albion Engineering Company, Moorestown, NJ (US)

(72) Inventors: Patrick M. White, Ocean View, DE (US); Jeffrey L. Serabo, Voorhees, NJ (US); Brian J. MacKenzie, Philadelphia, PA (US); Joseph B. Hanni, Cherry Hill, NJ (US)

(73) Assignee: Albion Engineering Company, Moorestown, NJ (US)

(21) Appl. No.: 19/195,799

(22) Filed: May 1, 2025

Related U.S. Application Data
(63) Continuation-in-part of application No. 18/890,060, filed on Sep. 19, 2024.

(51) Int. Cl. B05C 17/005

(52) U.S. Cl. CPC B05C 17/00586; B05C 17/00516

(57) ABSTRACT

The invention relates to a nozzle having a piercing projection for safe and efficient release of viscous material from a collapsible tube sealed at a front end and a rear end by tie clips when housed within a dispensing tool. The piercing projection extends from the nozzle interior surface. The piercing projection is arranged to pierce the front end of the collapsible tube along a tear line to form a flap of the collapsible tube to which the front end tie clip remains attached. An upstanding wall extends from the nozzle interior surface to define a retention shelf between the upstanding wall and the nozzle interior surface. The retention shelf is configured to receive and retain therein the flap and the front end tie clip during dispensing to enable unobstructed flow of the viscous material through the dispensing end opening.

### REFERENCE TO RELATED APPLICATIONS

This application is a continuation-in-part of U.S. patent application Ser. No. 18/890,060 filed Sep. 19, 2024. The disclosure of the above cited application is hereby incorporated herein by reference in its entirety.

### BACKGROUND OF THE INVENTION

This invention relates generally to dispensing devices, and more specifically to dispensing devices for viscous materials.

Dispensing devices for the application of various viscous material products such as caulking materials, dual component reactive resins, adhesives, sealants, and the like, are well known throughout many industries. Such dispensing devices ideally allow the viscous material to be applied in an accurate, mess-free, and waste-free manner.

Dispensing devices are often in the form of a dispensing gun, or caulking gun. Dispensing devices generally include a squeezable handle and trigger assembly which is operative for advancing the pistons of the dispensers and for maintaining the pistons in advanced positions when the trigger portions of the dispenser devices are released. The viscous materials can be packaged in a variety of forms; some of the most common are cartridge form, collapsible tubes, and bulk form.

Collapsible tubes are a popular form of container for viscous materials. Collapsible tubes have been known in the trade for many years and offer the benefits of providing good shelf stability for the contained chemicals, low package cost, and minimal packaging waste. Collapsible tubes are generally known in the art as a “sausage” or “chub.” Collapsible tubes have a collapsible wall often formed of a thin film material, that is sealed at each end using a tie clip usually formed of metal or plastic. While collapsible tubes can be used to contain non-reactive viscous material products, the collapsible tube is typically moisture impervious, thus allowing the collapsible tube to contain reactive viscous material products also (typically reactive viscous material products are ones that react when exposed to humidity in the air). All of these options (i.e., cartridge, bulk form, and collapsible form) can be employed in dual component dispensing devices as well as in single component dispensing devices.

Before dispensing from a collapsible tube, the user must remove the metal tie clip from its dispensing end. To do this, the user first pulls back a piston rod of the dispensing device and loads the collapsible tube most of the way into the barrel leaving a small portion exposed. Next, the user locates the metal tie clip at the exposed end for removal. Often, a small portion of the viscous material may cure just beneath the metal tie clip, which also must be removed. Using a razor, a pocket-knife, or a utility blade, the user snips the thin film material of the collapsible tube just below the metal tie clip to remove the metal tie clip and any cured viscous material to open the collapsible tube for dispensing. The user then loads the remaining portion of the collapsible tube into the barrel and replaces the front cap (with the nozzle extending therethrough) onto the barrel dispensing end and the dispensing device ready for dispensing. A problem exist with this approach because use of such sharp tools can often result in worker injuries, which is an issue for both workers and employers.

To address this problem, dispensing nozzles have been introduced that include one or more piercing features located on the interior surface of the nozzle body, thus eliminating the need for such sharp tools and reducing the potential for worker injury. The piercing features include piercing tips that protrude in a rearward direction through the inlet end of the nozzle to face the collapsible tube when loaded within the barrel. The collapsible tube is loaded into the barrel and the front cap (with the nozzle extending therethrough) is replaced on the barrel dispensing end. Upon squeezing the dispensing device trigger, force is applied against the collapsible tube pushing it in a forward direction and against the piercing tips of the nozzle which pierce the thin film material of the collapsible tube enabling viscous material to dispense through the nozzle. However, a difficulty arises because often the thin film material of the collapsible tube and/or the metal clip become lodged in the nozzle restricting flow of the viscous material during dispensing, which may only be a moderate problem if the viscosity of the fluids is very low but can be a great problem if the product viscosity is high and the product is pasty. Another difficulty is that if the outlet end of the nozzle is sufficiently large, the metal tie clip may pass through the nozzle and into the end product. Accordingly, there is a need for an improved nozzle having a piercing member that addresses these deficiencies.

### SUMMARY OF THE INVENTION

The invention relates to a nozzle having one or more piercing projections for safe and efficient release of viscous material from a collapsible tube sealed at a front end and a rear end by tie clips when housed within a dispensing device. The one or more piercing projections extend from the nozzle interior surface. The one or more piercing projections are arranged to pierce the front end of the collapsible tube along a tear line to form a flap of the collapsible tube to which the front end tie clip remains attached. An upstanding wall extends from the nozzle interior surface to define a retention shelf between the upstanding wall and the nozzle interior surface. The retention shelf is configured to receive and retain therein the flap and the front end tie clip to enable unobstructed flow of the viscous material through the dispensing end opening.

### BRIEF DESCRIPTION OF THE DRAWINGS

The present invention will hereinafter be described in conjunction with the appended drawing figures wherein like numerals denote like elements.

FIG. 1 is a perspective view of a piercing nozzle according to an exemplary embodiment of the present invention installed on an exemplary device for dispensing a viscous material from a collapsible tube;

FIG. 2 is an exploded view of the piercing nozzle, the dispensing device, and the collapsible tube of FIG. 1;

FIG. 3 is an enlarged perspective view of the piercing nozzle illustrating a piercing projection ;

FIG. 4 is an enlarged sectional view of the piercing nozzle illustrating an upstanding wall forming a retention shelf;

FIG. 5 is an enlarged sectional view of the piercing nozzle illustrating the piercing projection;

FIG. 6 is an enlarged bottom view of the piercing nozzle illustrating the piercing projection and the upstanding wall forming the retention shelf;

FIG. 7 is a perspective view of the piercing nozzle;

FIG. 8 is an enlarged sectional view of the piercing nozzle illustrating operation of the piercing projection and retention shelf during dispensing of viscous material from the collapsible tube;

FIG. 9 is an enlarged sectional view of the piercing nozzle illustrating operation of the piercing projection and retention shelf during dispensing of the viscous material from the collapsible tube;

FIG. 10 is an enlarged top view of the piercing nozzle during dispensing of viscous material from the collapsible tube;

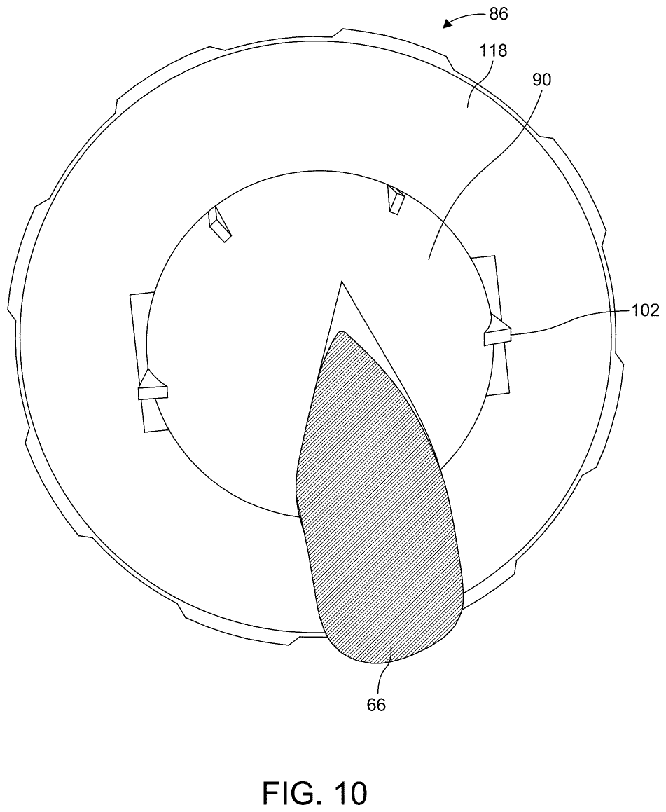

FIG. 11 is an enlarged view of the tip portion of a nozzle for dispensing a V-bead of a viscous material according to a first embodiment of the present invention;

FIG. 12 is a perspective view of the first embodiment nozzle for dispensing a V-bead of viscous material showing the nozzle positioned at an approximately 45-degree angle with respect to the work surface;

FIG. 13 is a perspective view of the first embodiment nozzle for dispensing a V-bead of viscous material showing the nozzle disposed in an upright position with respect to the work surface; and,

FIG. 14 is a perspective view of a prior art nozzle for dispensing a V-bead of viscous material.

FIG. 15 is a perspective view of a second embodiment nozzle for dispensing a V-bead of a viscous material according to the present invention;

FIG. 16 is an elevational view of the second embodiment nozzle for dispensing a V-bead of viscous material;

FIG. 17 is a chart illustrating lengths and cross-sections of V-beads produced by the second embodiment inventive nozzle compared with lengths and cross-sections of V-beads produced by the prior art nozzle;

FIG. 18 is an exploded view illustrating a method for attaching a collapsible tube containing a viscous material to an exemplary piercing nozzle;

FIG. 19 is a perspective view illustrating a portion of the collapsible tube of FIG. 18 attached to the exemplary piercing nozzle;

FIG. 20 is an exploded view illustrating a method for loading a collapsible tube containing a viscous material into a cartridge-type dispensing device using a reusable sleeve;

FIG. 21 is an enlarged bottom view of a piercing nozzle including a plurality of retention segments, each provided with an upstanding retention hook;

FIG. 22 is an enlarged sectional view of the piercing nozzle of FIG. 21 illustrating operation of the upstanding retention hooks during dispensing of viscous material;

FIG. 23 is an enlarged sectional view of the piercing nozzle of FIG. 21 illustrating operation of the upstanding retention hooks during dispensing of viscous material;

FIG. 24 is a perspective view of a piercing nozzle including an annular retention shelf and piercing projection;

FIG. 25 is a sectional view of the piercing nozzle of FIG. 24 illustrating details of the annular retention shelf and the piercing projection; and,

FIG. 26 is an enlarged bottom view of the piercing nozzle of FIG. 24 illustrating details of the annular retention shelf and piercing projection.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms are used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

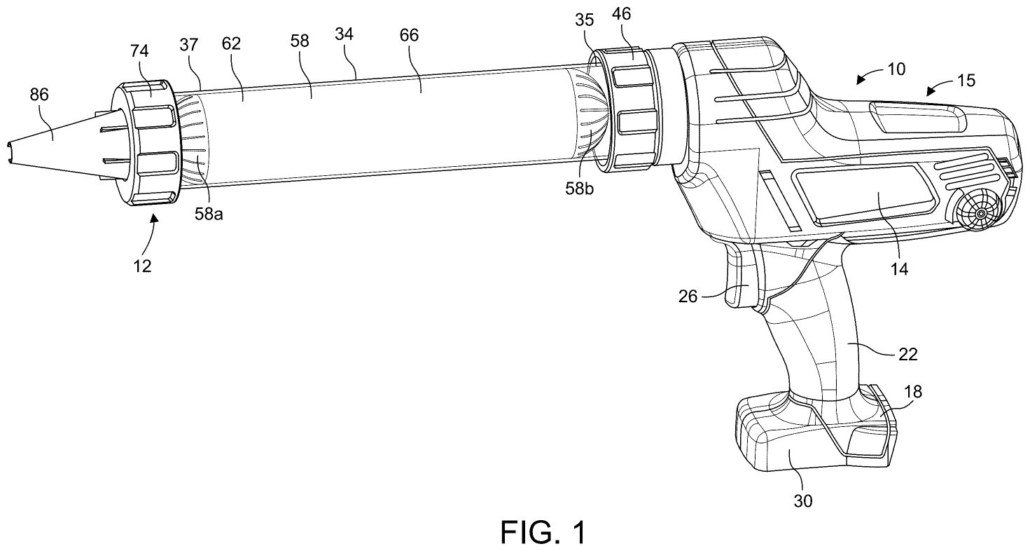

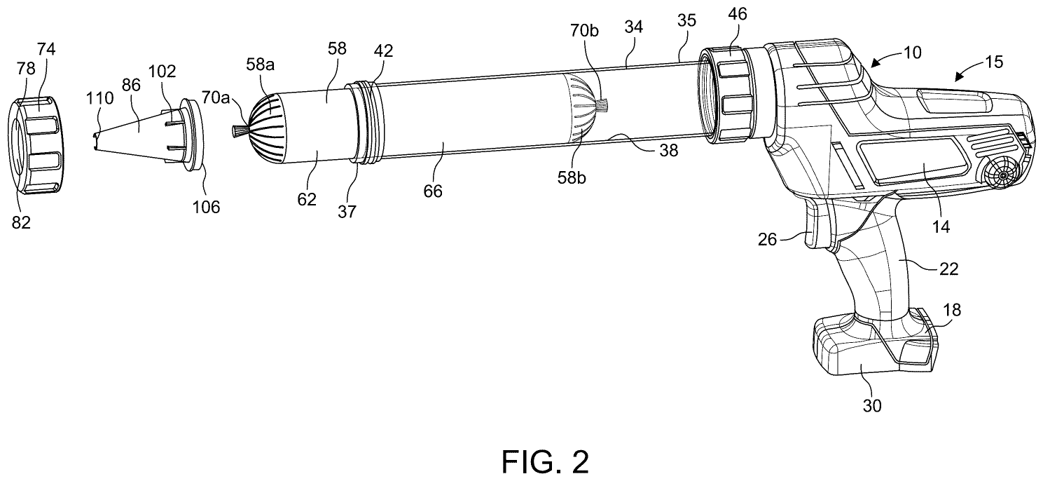

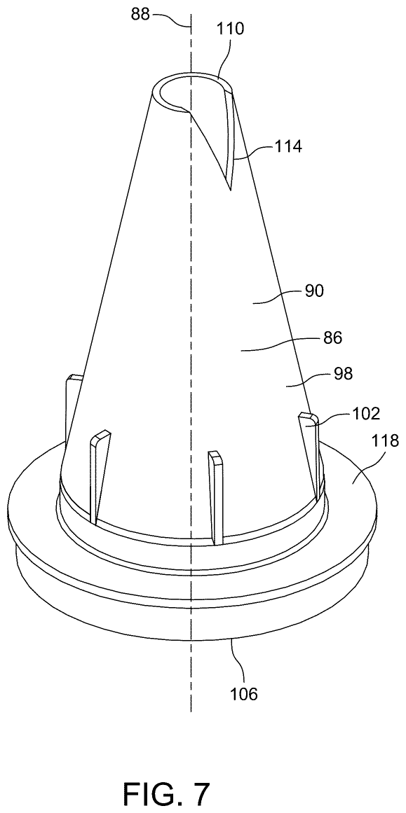

Referring now to FIGS. 1-2, there is shown a dispensing device 10 according to an exemplary embodiment of the present invention. The dispensing device 10 comprises a main body 14 to which a rear end cap 46 is attached. A barrel 34 extends forwardly from the main body 14 in axial alignment with the main body 14 and includes a fixed end 35 arranged for engagement, e.g., threaded engagement, with the rear end cap 46 and a dispensing end 37. At the dispensing end 37, the barrel is provided with external threads 42 that are engageable with internal threads on a front-end cap 74. The front-end cap 74 includes a central aperture adapted to receive a piercing nozzle 86 therethrough. As best illustrated in FIG. 7, the piercing nozzle 86 is provided with an annular shoulder 118 having a width or diameter substantially the same as the outer diameter of the barrel 34 such that when the internal threads of the front end cap 74 engage with the external threads 42 of the barrel 34, the nozzle 78 may be tightly retained between the front end cap 74 and the barrel dispensing end 37. The piercing nozzle 86 can be removably attachable to or integrally formed with the barrel dispensing end 37. It can be appreciated that other securing mechanisms can be utilized instead of threads such as, but not limited to, clips, latches, locks or magnets.

As best shown in FIGS. 1 and 2, a collapsible tube 58 containing a supply of viscous material such as caulking or sealant materials is shown disposed within the barrel 34. It can be appreciated that the collapsible tube 58 can include any cylindrically shaped or sausage-shaped casing 62 that is collapsible and contains an extrudable material therein. In the exemplary embodiment, the extrudable material can be, but not limited to, a sealant, grease, a lubricant, food materials, a caulking material, a paste, mixable compounds, a filler and the like. As best shown in FIG. 2, the collapsible tube 58 includes a front end 58a wherein the casing 62 is gathered, tied off, and sealed using a front closure clip 70a, and a rear end 58b wherein the casing 62 is gathered, tied off, and sealed using a rear closure clip 70b.

A hand grip 22 extends integrally and angularly from the main body 14 to present a pistol-like appearance. The main body 14 may include a battery receptacle 18 positioned at a base of the dispensing device 10 and may be configured to receive a battery 30 (e.g., a power tool battery pack). The battery receptacle 18 may include an attachment mechanism (e.g., actuating latches-not shown) to removably couple the battery 30 to the battery receptacle 18. In some embodiments, the battery 30 may be an 18 V battery. Mounted within the main body 14 is an electric motor (not shown) which is energized by squeezing a trigger 26 which is moveable with respect to the hand grip 22. In some embodiments, the hand grip 22 may be at least partially formed from an elastomeric material (e.g., rubber) to assist the user in maintaining a firm grasp on the hand grip 22. In some embodiments, the hand grip 22 may be provided with a trigger lock (not shown) which is moveable between an unlocked position and a locked position in which the trigger lock prevents actuation of the trigger 26.

Upon being energized, the motor drives a compression assembly 15 housed within the main body 14 and extending into the barrel 34 to compress the collapsible tube 58 to dispense the viscous material 66 from the collapsible tube 58 and through the piercing nozzle 86. It can be appreciated that the compression assembly may include a plunger mechanism (not shown) driven by the motor through a gear system. As the plunger assembly moves distally within the barrel 34, it compresses the collapsible tube 58 to expel the viscous material 66 contained therein.

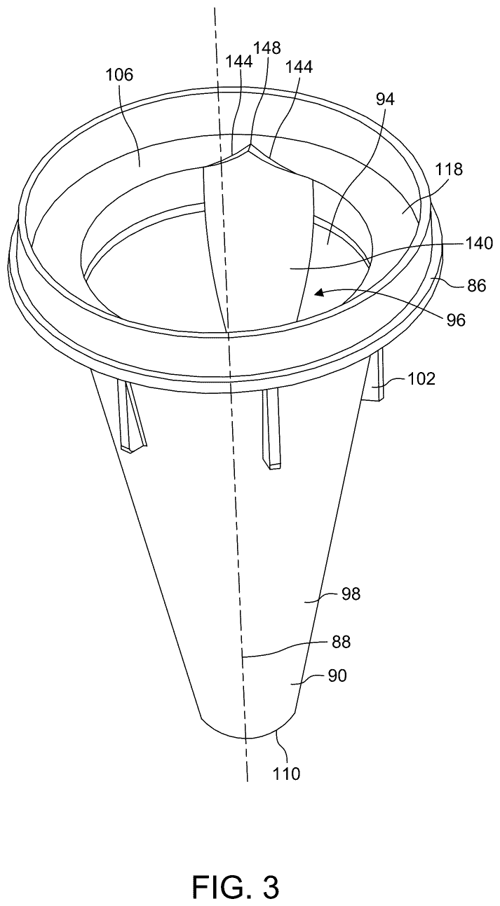

The piercing nozzle 86 can be configured to assist in dispensing and/or spreading material dispensed from the collapsible tube 58 onto a surface or into a gap. The nozzle 86 can be made of, but not limited to, plastic, metal, composite, an alloy or any combination thereof. With reference to FIGS. 3-9, an exemplary embodiment of the piercing nozzle 86 is illustrated and will be described. The piercing nozzle 86 can include a body featuring a nozzle sidewall 90 defining a nozzle cavity 96, an interior surface 94, an external surface 98, a receiving end opening 106 configured to receive viscous material 66 from the front end 58a of the collapsible tube 58, a dispensing end opening 110, and a central longitudinal axis 88. The nozzle 86 may include a tapered profile in which the receiving end opening 106 is wider than the dispensing end opening 110. A width or diameter of the receiving end opening 106 can be substantially the same as the width or diameter of the collapsible tube 58 so that they contact each other during use and allow the collapsible tube front end 58a to easily travel into the nozzle cavity 96.

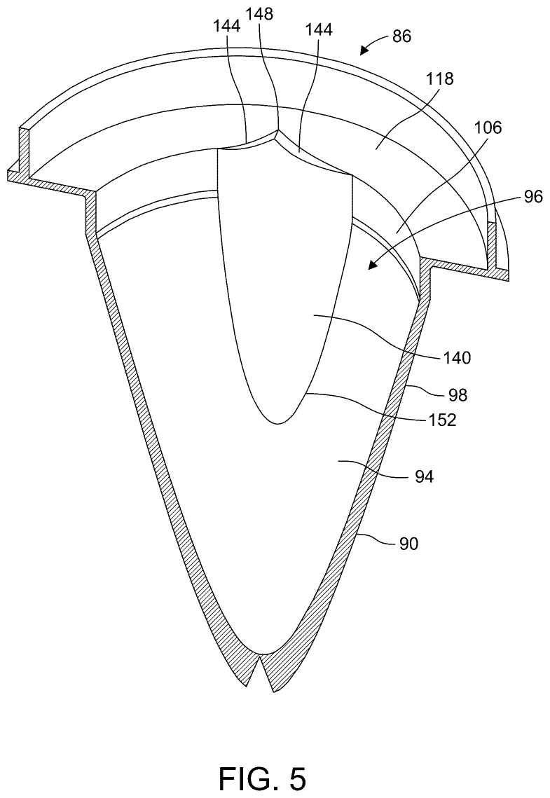

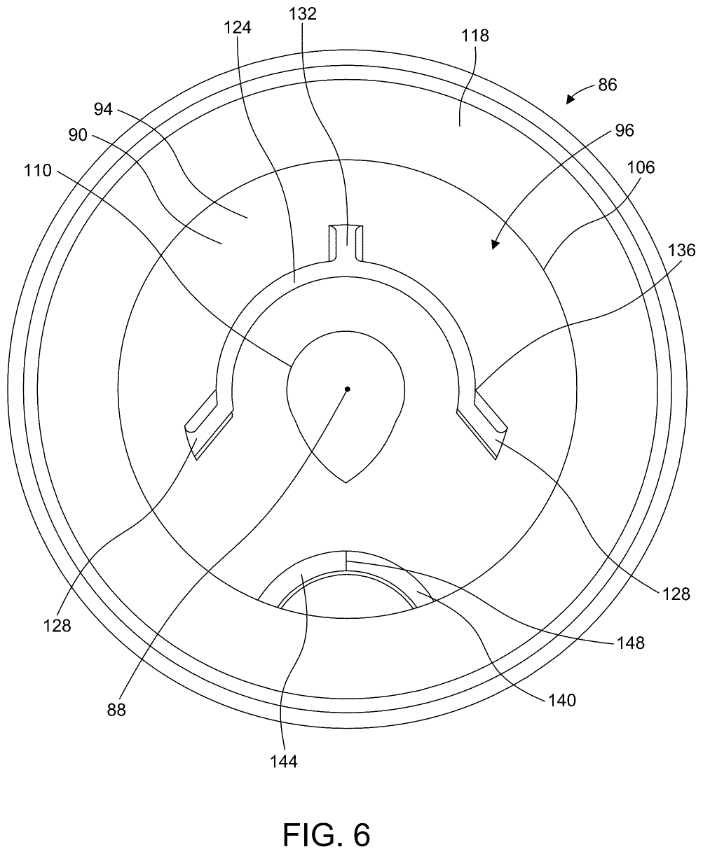

As best illustrated in FIGS. 3, 5, and 6, a piercing projection 140 extends from the interior surface 94 of the nozzle 86. In the exemplary embodiment, one piercing projection 140 is shown. In alternative embodiments, more than one piercing projection 140 may extend from the nozzle interior surface 94. As best illustrated in FIG. 6, the piercing projection 140 includes an arcuate body that extends inwardly from the nozzle interior surface 94 into the nozzle cavity 96. As best illustrated in FIG. 5, the piercing projection 140 is situated on the nozzle interior surface 94 at a location that is upstream and proximate to the receiving end opening 106 of the nozzle 86. The piercing projection 140 includes a peripheral edge 152 that is contoured for securement to the nozzle interior surface 94. Alternatively, the piercing projection 140 may be integrally formed with the nozzle interior surface 94.

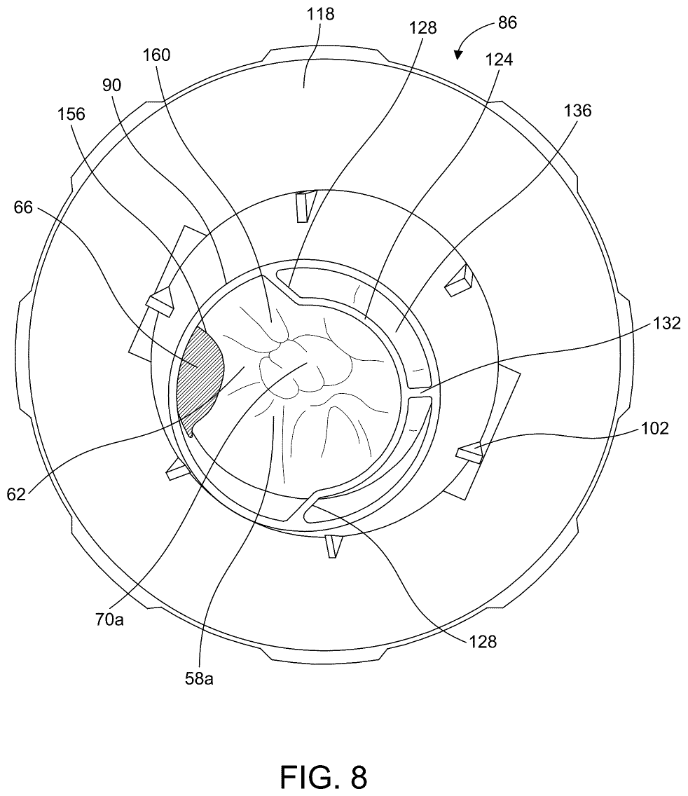

The piercing projection 140 includes a pair of inclined surfaces 144 that slope upwardly and converge at a piercing tip 148 that points backwards or upstream towards the collapsible tube 58 when disposed within the barrel 34. In alternative embodiments, the piercing tip 148 may extend through the receiving end opening 106 in the upstream direction. Also, in alternative embodiments, the inclined surfaces 144 could be curved or planar. The piercing tip 148 may be configured to easily pierce or puncture the casing 62 of the collapsible tube 58 when the collapsible tube 58 is pressed against the piercing tip 148 by the compression assembly. Referring now to FIG. 6, in the exemplary embodiment, the piercing projection 140 is offset from a central longitudinal axis 88 of the nozzle 86 so as to not obstruct the dispensing end opening 110, thereby maintaining a clear path for viscous material to pass or travel through during dispensing. Referring now to FIG. 8, once pierced, the casing 62 of the collapsible tube 58 will tear along a tear line 156 to form a flap 160 of the casing 62 to which the front closure clip 70a will remain attached.

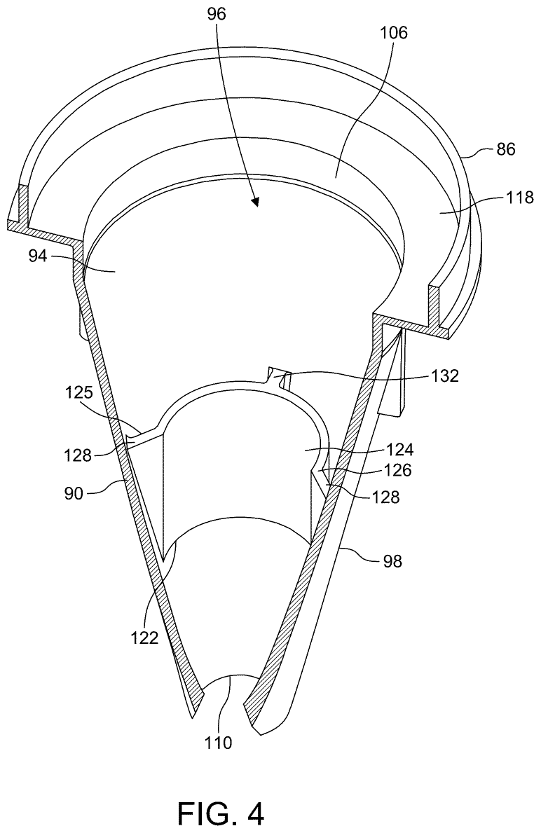

As best illustrated in FIGS. 4, 6, 8, and 9, an upstanding wall 124 is shown extending within the nozzle interior surface 94. In the exemplary embodiment, the upstanding wall 124 forms a portion of a cylinder. The upstanding wall 124 includes a base edge 122 shaped to secure the upstanding wall 124 to the nozzle interior surface 94. Alternatively, the upstanding wall 124 may be integrally formed with the nozzle interior surface 94. From the base edge 122, the upstanding wall 124 extends towards the receiving end opening 106. As best illustrated in FIG. 4, the upstanding wall 124 is situated on the nozzle interior surface 94 at a location that is downstream and proximate to the dispensing end opening 110 of the nozzle 86. Thus, the piercing projection 140 is situated on the nozzle interior surface 94 at a relatively upstream position, while the upstanding wall 124 is situated on the nozzle interior surface 94 at a relatively downstream position. In addition, as best shown in FIG. 6, in some embodiments, the piercing projection 140 and the upstanding wall 124 may be located at opposed sides on the nozzle interior surface 94.

As best illustrated in FIG. 4, the upstanding wall 124 includes a first end 125 and a second end 126. In the exemplary embodiment, a plurality of support ribs 128 are provided that extend from the first end 125 and the second end 126 to the interior surface 94 of the piercing nozzle 86 to provide the upstanding wall 124 with a degree of rigidity. Support ribs may also be positioned at locations along the length of the upstanding wall 124 to provide additional rigidity to the upstanding wall 124. For example, an additional support rib 132 may be located approximately midway along the length of the upstanding wall 124 between the first end 125 and the second end 126. The support added by the ribs 128 and 132 enable the upstanding wall 124 to remain rigid as the viscous material 66 flows through the nozzle 86. As best shown in FIG. 6, due to its partial cylindrical configuration, the upstanding wall 124 is offset from the dispensing end opening 110 so as to not obstruct it, thereby maintaining a clear path for the viscous material 66 to pass or travel through during dispensing.

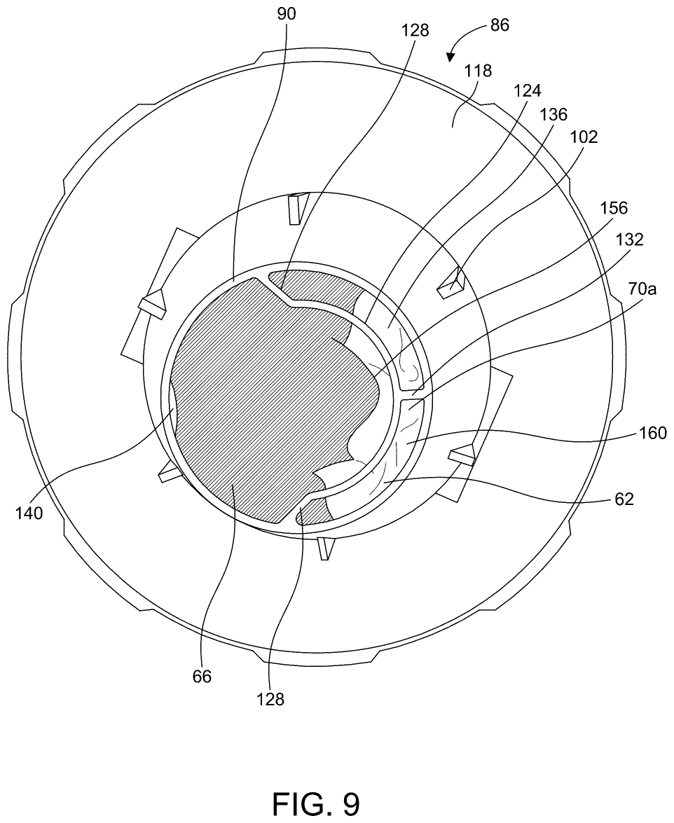

As best shown in FIGS. 6, 8, and 9, as the upstanding wall 124 extends from the base edge 122, a retention shelf 136 is formed between the nozzle interior surface 94 and the upstanding wall 124. The retention shelf 136 extends the length of the upstanding wall 124 between the first end 125 and the second end 126. Referring now to FIGS. 8 and 9, as the collapsible tube 58 is pressed against the piercing tip 148, the casing 62 in proximity to the front end 58a is pierced to expel the viscous material 66 therefrom. In FIG. 8, an initial amount of viscous material 66 is shown being expelled from the collapsible tube 58. As the collapsible tube 58 continues to be compressed, the piercing tip 148 continues to tear through the casing 62 along the tear line 156 to form a flap 160. The front closure clip 70a remains attached to the flap 160. In FIG. 9, as more viscous material 66 is expelled from the collapsible tube 58 and travels downstream through the nozzle 86, the viscous material 66 pushes the flap 160 and front closure clip 70a downwardly through the nozzle 86 and into the retention shelf 136 and out of the way, thereby providing clear passage for easy flow of the viscous material 66 through the dispensing end opening 110 of the nozzle 86. In this manner, the retention shelf 136 prevents the problem of the flap 160 and/or front closure clip 70a becoming lodged in the dispensing end opening 110 to prevent or limit the flow of viscous material therethrough. In some embodiments, once dispensing is complete, the front end cap 74 may be removed from the first barrel end 35, and the nozzle and collapsed tube 58 may be removed from the front cap 74 and discarded. It has been found that for most products such as caulk, dual component reactive resins, adhesives, and sealants, it is optimal to employ a single piercing projection 140 situated on the nozzle interior surface 94 at a location that is relatively upstream and opposite the location of the retention shelf 136. However, it can be appreciated that for some products, especially those formed of a softer material or having a lower viscosity, it may be preferable to employ two or more piercing projections 140 positioned on the nozzle interior surface 94 at locations upstream and opposite the location of the retention shelf 136.

It should be understood that although the inventive nozzle 86 is described as utilized in combination with a battery-operated dispensing device, this type of dispensing device is merely exemplary, and in other embodiments, the inventive nozzle 86 may be used with other types of conventional powered dispensing devices such as electrically powered and pneumatically powered dispensing devices or may be utilized in combination with conventional manual mechanical style dispensing devices (not shown).

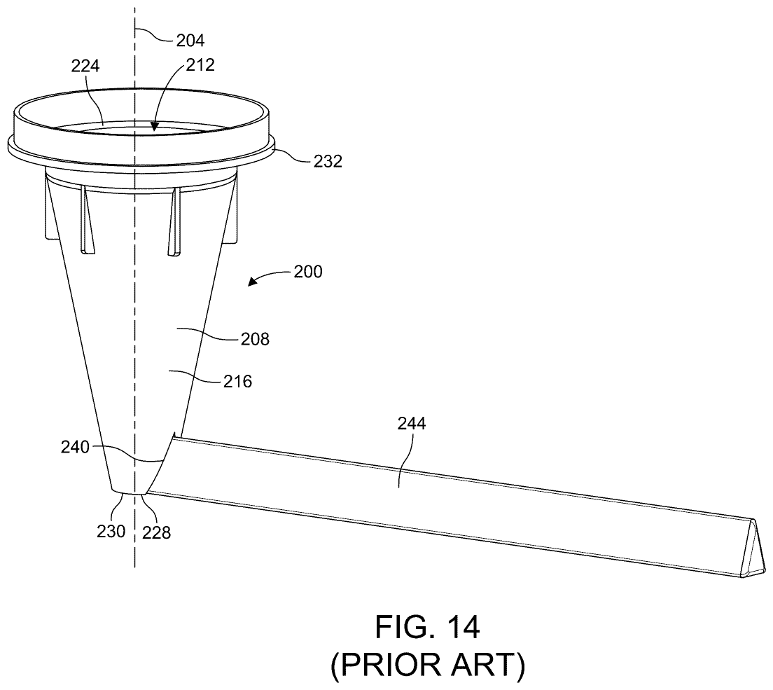

Referring now to FIG. 14, there is shown a prior art dispensing nozzle 200 for dispensing a viscous material such as an adhesive during installation of automobile glass, such as windshields. The nozzle 200 includes a sidewall 208 defining a cavity 212, an external surface 216, a receiving end opening 224, a dispensing end opening 228, and a central longitudinal axis 204. The nozzle 200 is shaped as a cone with the receiving end opening 224 wider than the dispensing end opening 228. The nozzle 200 may be provided with an annular shoulder 232 to enable its retention to a dispensing device, as described above.

The dispensing end opening 228 includes a generally circular aperture 230 located at the tip of the nozzle 200. The generally circular aperture 230 is oriented perpendicular to the central longitudinal axis 204. The dispensing end opening 228 also includes an inverted V-shaped notch 240 formed in the sidewall 208 and extending upwardly from the generally circular aperture 230. The inverted V-shaped notch 240 is in fluid communication with the generally circular aperture 230. This nozzle tip arrangement including the generally circular aperture and V-shaped notch could optionally be employed as part of the inventive nozzle 86 attached at the barrel dispensing end 37 as best illustrated in FIGS. 2 and 7.

In many applications, such as the installation of a windshield during automobile assembly, it is critical that a dispensed V-bead 244 of adhesive be consistent in cross-sectional shape along its length to ensure an effective seal and bond of the windshield glass to the automobile at all points. To accomplish this, the installer must position the dispensing device at 90 degrees to the work surface (perpendicular), as shown in FIG. 14, and bring the circular aperture 230 of the nozzle 200 into contact with the work surface such that the viscous material is dispensed onto the work surface solely through the inverted V-shaped notch 240 to form the V-bead, and is blocked from being dispensed through the circular aperture 230 which can corrupt the uniform cross-sectional shape of the V-bead. However, in many workplaces, such as during the installation of auto glass, maintaining the nozzle 200 in this upright orientation on the work surface can be difficult, as access to the work surface can be difficult. When handling automobile windshields weighing 50-60 pounds, an installer must be able to maneuver the glass at various different angles and orientations, requiring constant repositioning of the nozzle 200 as the position of the installer changes. If the installer is unable to maintain the dispensing device in this upright orientation and in contact with the work surface during dispensing, the resulting adhesive bead 244 will be uneven and unsatisfactory.

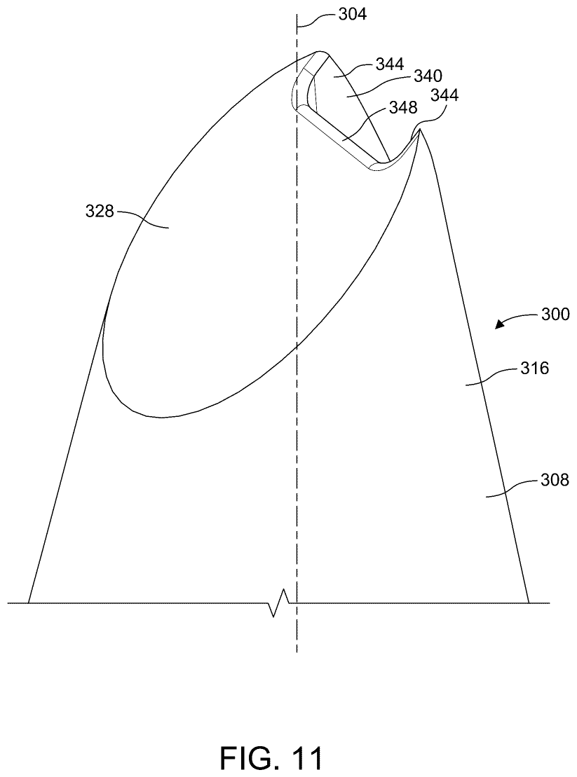

Referring now to FIGS. 11-13, the present invention addresses these drawbacks by providing a nozzle 300 having a configuration that eliminates the circular aperture 230 of the prior art nozzle 200 leaving only a V-shaped outlet orifice 340 for dispensing a V-bead 352 to provide the installer with greater flexibility during use. The inventive nozzle 300 includes a cone-shaped sidewall 308 defining an internal cavity 312, a receiving end opening 324, the outlet orifice 340, and a central longitudinal axis 304. The receiving end opening 324 may be wider than the dispensing end opening 344, and the nozzle 300 may be provided with an annular shoulder 332 to enable retention to the dispensing device, as described above. The dispensing nozzle 300 can be arranged for dispensing from cartridges which are usually used for containing adhesives, but also can be arranged for dispensing viscous materials in bulk form, or from a collapsible tube (sausage tube).

As best shown in FIG. 11, the cone-shaped sidewall 308 tapers to a truncated portion which defines a flat wall 328. As shown in the exemplary embodiment, the flat wall 328 is generally oval-shaped but could be other shapes. The flat wall 328 may be inclined at a first angle, e.g., an acute angle, relative to a central longitudinal axis 304. As the flat wall 328 extends from the receiving end opening 324, it widens, then narrows, and then converges with an outlet orifice 340 formed in the cone-shaped sidewall 308. In the exemplary embodiment, the outlet orifice 340 is an inverted V-shaped notch for dispensing a V-bead 352 of viscous material such as adhesive. The outlet orifice 340 may include a bottom wall 348 and end walls 344. The end walls 344 may extend upwardly from the bottom wall 348 to converge at an apex 346 to form a triangle. The bottom wall 348 may coincide with the bottom edge of the flat wall 328.

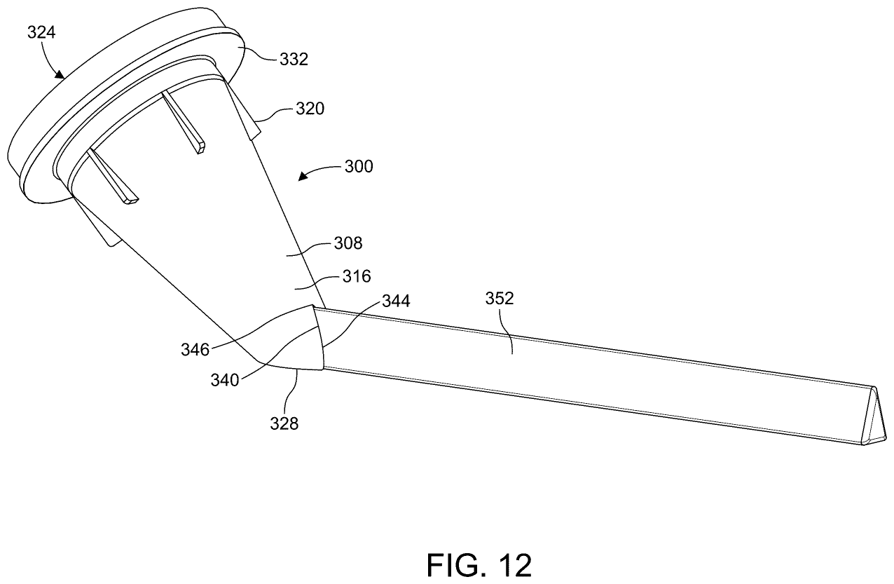

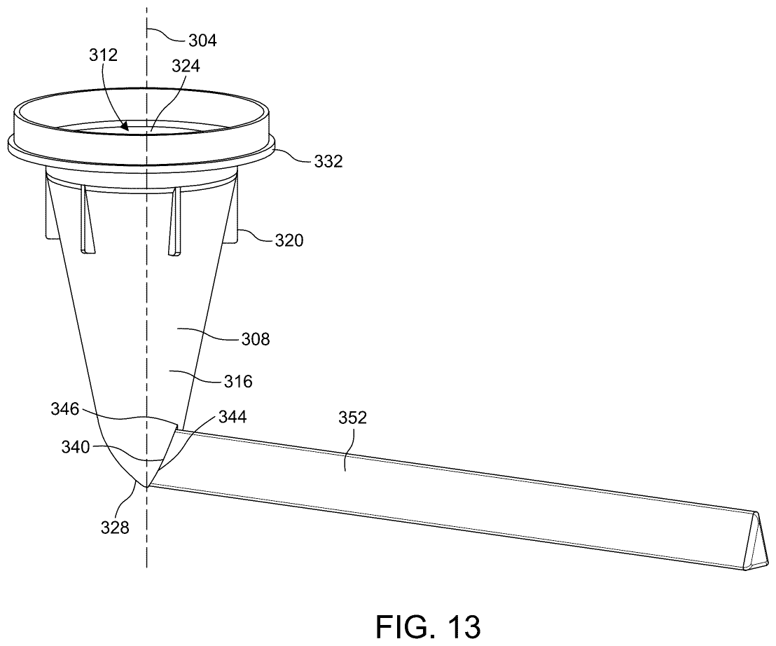

As best shown in FIG. 13, the outlet orifice 340 may be inclined at an angle, e.g., an acute angle, relative to the central longitudinal axis 304. Under the inventive nozzle 300, the viscous material can only dispense through the outlet orifice 340, as the circular aperture 230 of the prior art nozzle 200 has been eliminated due to the inclusion of the flat wall 328. In this manner, during dispensing, an installer may hold the dispensing device and nozzle 300 attached thereto at the 90-degree position relative to the work surface as best shown in FIG. 13, or at a 45-degree position relative to the work surface, as best shown in FIG. 12, or at a range of angular positions between the 90-degree position and the 45-degree position during dispensing. Regardless of the angular position during dispensing, due to the geometry of the nozzle outlet orifice 340 and elimination of the circular aperture 230, the resulting dispensed V-bead 352 will be consistent in shape along its length to ensure an effective seal and bond of the windshield glass to the automobile at all points.

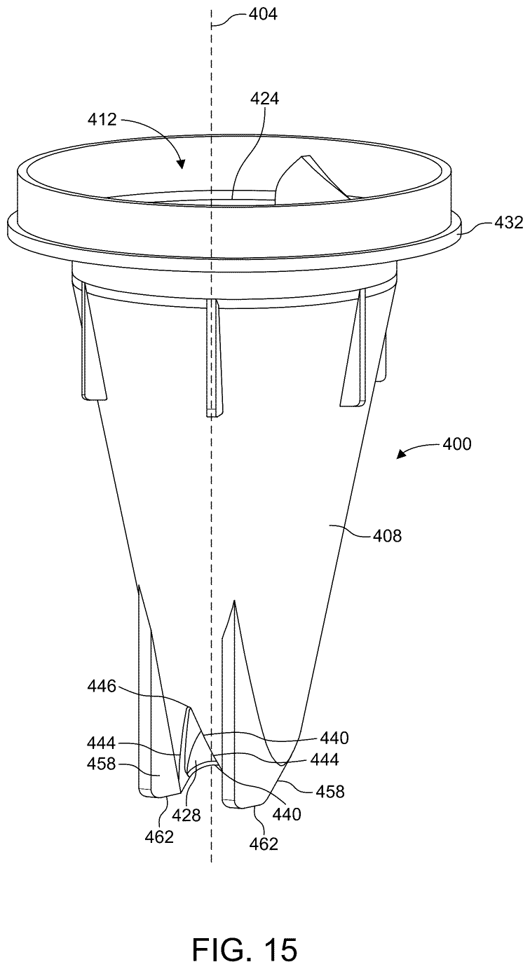

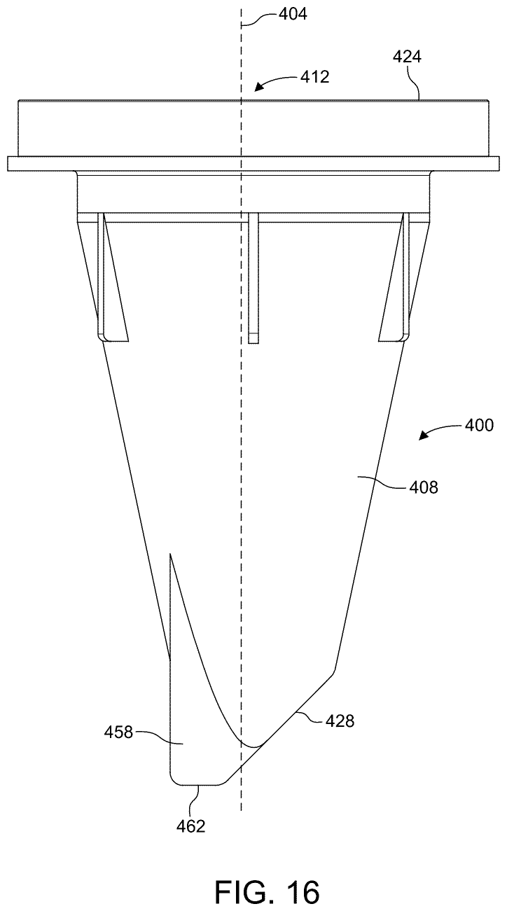

Referring now to FIGS. 15 and 16, there is shown a second embodiment of the inventive nozzle 400 for dispensing a V-bead of viscous material. As with the first embodiment, the nozzle 400 of the second embodiment includes a cone-shaped sidewall 408 that tapers down to a truncated portion which defines a flat wall 428. Also, as with the first embodiment, the flat wall 428 is generally oval-shaped but could be other shapes. As shown in FIG. 16, the flat wall 428 may be inclined at a first angle, e.g., an acute angle, relative to a central longitudinal axis 404. As with the first embodiment, as the flat wall 328 extends from the receiving end opening 424, it widens, then narrows and converges with an outlet orifice 440 formed in the cone-shaped sidewall 408. In the exemplary embodiment, the outlet orifice 340 includes an inverted V-shaped notch for dispensing a V-bead 452 of viscous material such as adhesive. The V-shaped notch may include end walls 444 that extend upwardly to converge at an apex 446.

The inventive nozzle 400 is provided with a pair of opposed stabilizing feet 458 in proximity to the outlet orifice 440 of the nozzle 400. The stabilizing feet 458 are provided to improve stability when dispensing while the nozzle 400 is oriented in the 90-degree position with respect to the work surface. Each of the stabilizing feet 458 is provided with a flat bottom surface 462 increasing the overall area of contact between the nozzle 400 and the work surface when in the 90-degree position. In this manner, the stabilizing feet 458 enable the user to more easily maintain the 90-degree orientation of the nozzle 400 while applying a V-bead, such as to an automobile windshield. The stabilizing feet 458 also provide a degree of added stability when dispensing at a 45-degree position, or in a range of positions between the 90-degree position and the 45-degree position. As shown in FIGS. 15 and 16, the stabilizing feet 458 may be oriented parallel to one another. Alternatively, the stabilizing feet 458 may be oriented in non-parallel positions. The stabilizing feet 458 eliminate the existence of any points at the tip end of the nozzle 400 which could cause tearing if the V-bead 452 is being applied to a soft work surface.

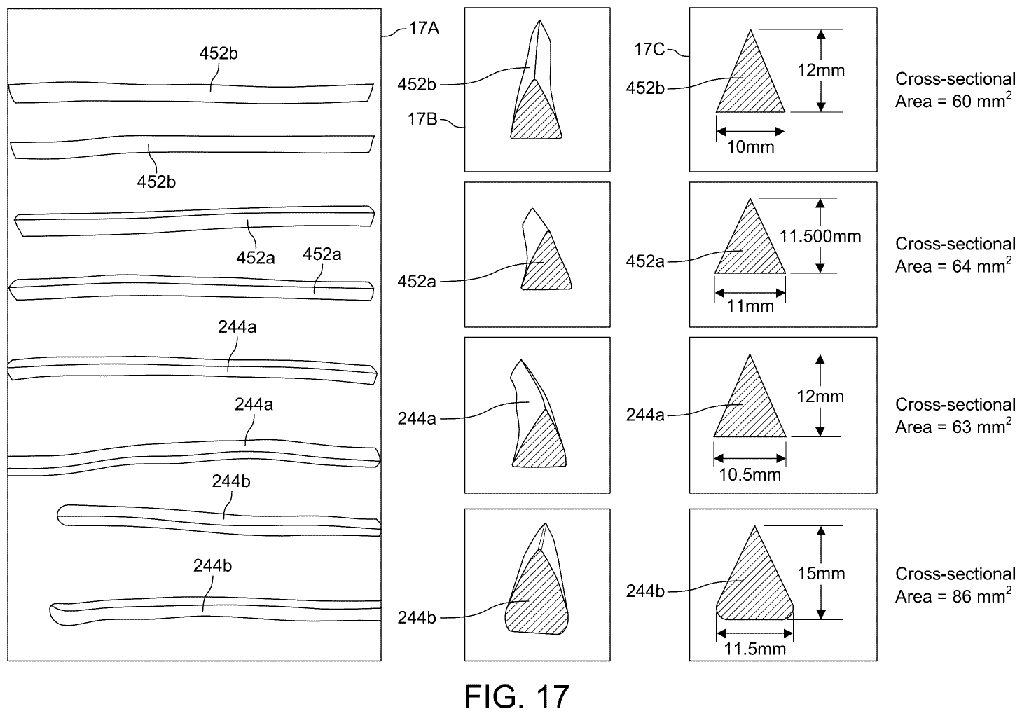

Referring now to FIG. 17, the left-most panel 17A illustrates actual lengths of V-beads 452a and 452b dispensed from the inventive nozzle 400 at 90 and 45-degree orientations, respectively, and actual lengths of V-beads 244a and 244b dispensed from the prior art nozzle 200 at 90 and 45-degree orientations, respectively. The center panel 17B illustrates the corresponding cross sections of these V-beads, and the right-most panel shows a calculation of the cross-sectional areas of these V-beads.

The illustrations of the center panel 17B show that the V-bead 452a dispensed from the inventive nozzle 400 in the 90-degree position produces a triangular cross-section having an apex centered over the end walls when compared with the V-bead 244a dispensed from the prior art nozzle 200 where the apex appears right of center, which in certain applications may be unacceptable. The right-most panel 17C shows that the cross-sectional areas of these beads 452a and 244a, are approximately equal, i.e., 64 mm²v. 63 mm². Thus, the inventive nozzle 400 uses approximately the same amount of viscous material as the prior art nozzle 200 during dispensing, but achieves a more uniform cross-section.

The center panel 17B also shows that the V-bead 452b dispensed from the inventive nozzle 400 in the 45-degree position produces a triangular cross-section having sharp base corners, while the V-bead 244b dispensed from the prior art nozzle 200 has rounded base corners resulting from its having the circular aperture 230. Such rounded corners are unacceptable in certain applications such as windshield installation. Also, the right-most panel 17C demonstrates the prior art nozzle 200 using substantially more viscous material during dispensing than the inventive nozzle 400, i.e., 86 mm² cross-sectional area for the V-bead 244b v. 60 mm² cross-sectional area for the V-bead 452b dispensed inventive nozzle 400.

In the marketplace, the most prevalent tool for dispensing viscous materials is the cartridge-type dispensing tool, which includes a carriage assembly for holding a cartridge. The cartridge can hold a variety of viscous materials such as adhesives, caulking materials, or sealants to be dispensed through a cartridge nozzle. When the user pulls the trigger, the dispensing tool applies pressure to the cartridge through a piston to force the viscous material out of the cartridge nozzle at a controlled rate. The cartridge is most common due to its ease of use, readily available packaging, and compatibility with a wide range of standard dispensing tools. However, there are drawbacks. For example, cartridges tend to be more expensive per unit volume compared to sausage or bulk options. Also, due to their rigid structure, cartridges increase job site and landfill waste. Also, cartridges may not be fully emptied with viscous material left inside contributing to waste.

Collapsible tubes, commonly referred to as sausages, tend to be more emptied after use. Also, as viscous material is dispensed from the collapsible tube, it flattens which further reduces waste. However, collapsible tubes are often used for larger volumes of viscous material and may not be as widely prevalent as cartridges due to the need for specialized dispensing tools. The cartridge-type dispensing tool is not well-suited for dispensing viscous material from collapsible tubes. Accordingly, there is a need to adapt the cartridge-type dispensing tool to enable dispensing from collapsible tubes to obtain the benefits collapsible tubes provide.

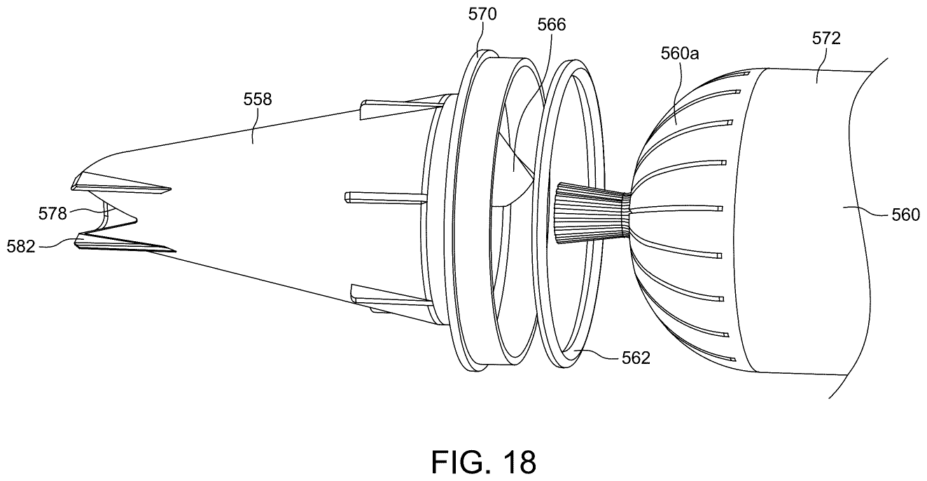

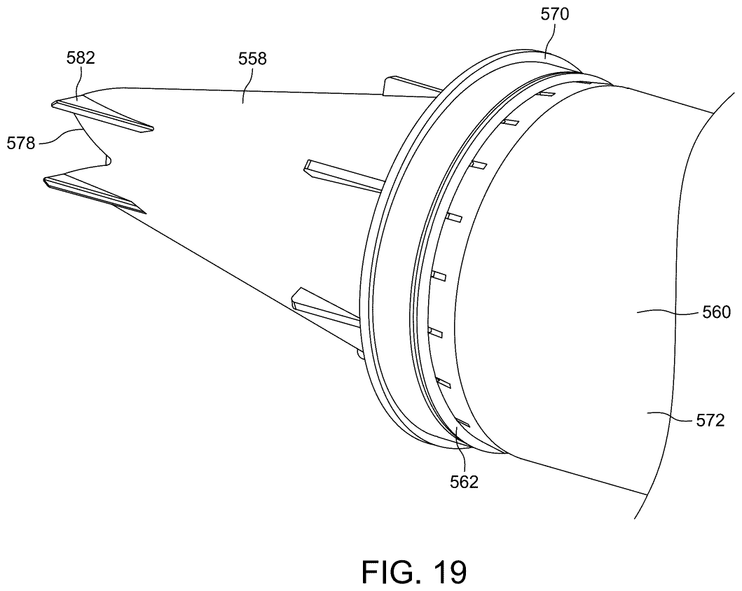

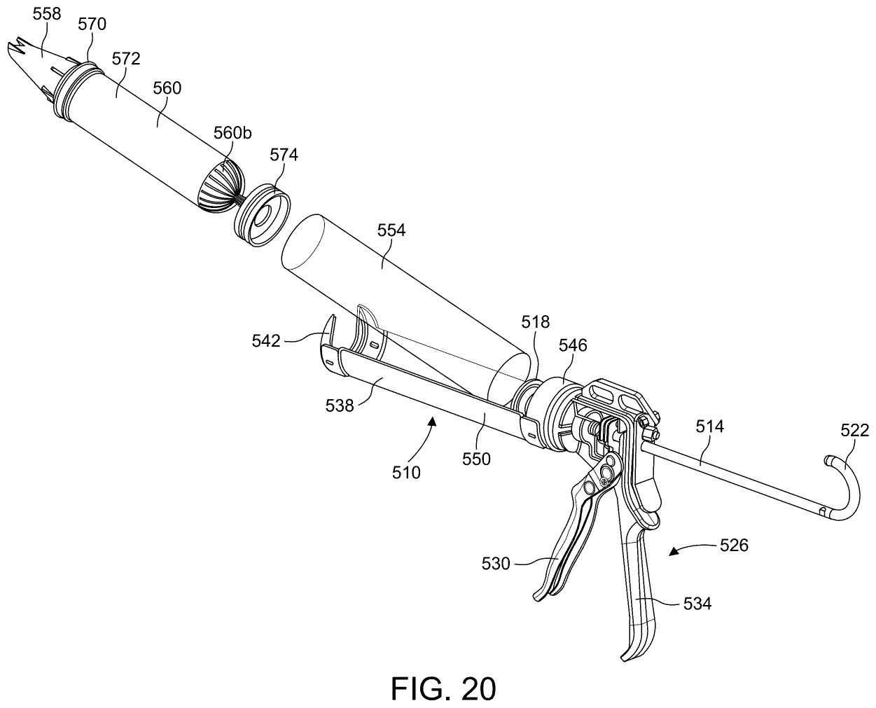

Referring now to FIGS. 18-20, the present invention addresses these drawbacks by providing a rigid sleeve 554 and a piston ring 574 to enable use of a cartridge-type tool 10 for dispensing from a collapsible tube 560. In FIG. 20, there is shown a typical cartridge-type dispensing tool 510 which includes a piston rod 514 having a threaded end to which an ejector 518 is attached, and a return hook 522. The piston rod 514 is adapted to be disposed in sliding relation within a trigger assembly 526. The trigger assembly 526 includes an operating trigger 530 and an associated handle grip 534. The trigger 530 is pivotally mounted to the trigger assembly 526 by a pin. In known ways, pivotal motion of the trigger 530 is translated into linear motion of the piston rod 514 and ejector 518. Hence, actuation of the trigger 530 moves the piston rod 514 and ejector 518 in an axial direction.

The cartridge-type dispensing tool 510 includes a forward section in the form of a carriage assembly 538 of conventional design intended for housing the cartridge (not shown). The carriage assembly 538 includes a front wall 542, a rear wall 546, and spaced axial strap members 550 connected rigidly between these walls, as by welding or bolts (not shown). The front and rear walls 542, 546 and strap members 550 are separated sufficiently to allow a cartridge to be positioned therebetween. Thus, the front and rear walls 542, 546 are spaced apart by a distance slightly exceeding the length of the cartridge, and the strap members 550 are separated by a distance slightly exceeding the diameter of the cartridge. Lateral enforcement straps may be provided to lend stability to the strap members 550.

The cartridge (not shown) is of standard size and configuration and comprises a tubular cylindrical body containing the viscous material to be dispensed, a movable plunger at the rearward end of the body, and a dispensing nozzle attached at the forward end. When the cartridge is appropriately registered within the carriage assembly 538, and the trigger 530 is actuated, the piston rod 514 and ejector 518 apply a force moving the cartridge plunger in a forward ejecting direction towards the cartridge nozzle to expel material from the cartridge. The trigger 530 is caused to return to its original position for a repeat of the action detailed above. Once the viscous material has been dispensed from the cartridge, the piston hook 522 can be pulled to return the ejector 518 to its initial position for removal and replacement of the cartridge.

Under the present invention, a rigid sleeve 554 is provided to enable use of the cartridge-type dispensing tool 510 for dispensing from a collapsible tube 560. The rigid sleeve 554 is arranged to house the collapsible tube 560. The rigid sleeve 554 may be made of a rigid or hard plastic or plastic-like material, a metal material, or other suitable compounds or materials. The rigid sleeve 554 may include a thin-walled tubular body portion that is cylindrical and may include a diameter and length approximately equal to the cartridge so that it can be appropriately registered within the carriage assembly 538 between the front and rear walls 542, 546, and strap members 550. In FIG. 20, the rigid sleeve 554 is shown as being made of a suitable transparent material so that the collapsible tube 560 housed therein can be observed as it flattens during dispensing. Alternatively, the rigid sleeve 554 may be made of a suitable translucent or non-transparent material. A piston ring 574 is provided for fitting over the ejector 518. The piston ring 574 includes an outer diameter shaped to fit closely and in a substantially sealed relationship with the inside surface of the rigid sleeve 554 to avoid pinching of the collapsible tube 560 during dispensing.

The collapsible tube 560 can include any cylindrically shaped or sausage-shaped casing 572 that is collapsible and contains an extrudable viscous material therein. The collapsible tube 560 includes a front end 560a wherein the casing 572 is gathered, tied off, and sealed using a front closure clip, and a rear end 560b (FIG. 20) wherein the casing 572 is gathered, tied off, and sealed using a rear closure clip. A nozzle 558 is shown attached to the front end 560a of the collapsible tube 560 before the resulting assembly is loaded into the rigid sleeve 554 behind the piston ring 574. The nozzle 558 may be attached to the front end 560a of the collapsible tube 560 by any conventional means, such as gluing, heat sealing, ultrasonic welding, compression fitting, and the like. For example, the nozzle 558 may be glued to the collapsible tube 560 using a bead 562 of a suitable adhesive material. With the resulting assembly loaded into the rigid sleeve 554 behind the piston ring 574, the rigid sleeve 554 may be registered within the carriage assembly 538. With the rigid sleeve 554 appropriately registered within the carriage assembly 538, the piston ring 574 may be fitted over the ejector 518. The nozzle 558 includes an annular shoulder 570 that abuts the front wall 542 of the carriage assembly 538 to tightly retain the nozzle 558 collapsible tube 560 attached thereto within the carriage assembly 538. The tapered portion of the nozzle 558 extends through an open-ended slot 544 in the front wall 542. Optionally, the nozzle 558 may include one or more of the inventive features discussed above including a piercing projection 566, an inverted V-shaped notch 578, and/or opposed stabilizing feet 582.

Upon actuation of the trigger 530, the piston rod 514 and ejector 518 apply a force moving the collapsible tube 560 in a forward ejecting direction towards the nozzle 558 to expel material from the nozzle 558. As the collapsible tube 560 is forced in the ejecting direction, it flattens upon itself. The trigger 530 is caused to return to its original position for a repeat of the action detailed above. Once the viscous material has been dispensed from the collapsible tube 560, the piston hook 522 can be pulled to return the ejector 518 to its initial position and the rigid sleeve 554 can be removed from the carriage assembly 538. Once removed, the flattened collapsible tube 560 with the nozzle 558 attached thereto may be removed from the rigid sleeve 554 for disposal and replacement with an unused collapsible tube 560.

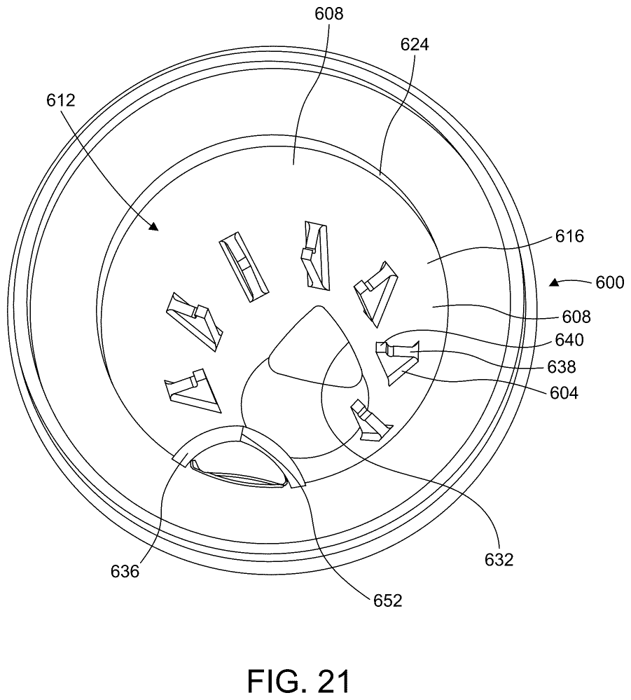

Referring now to FIGS. 21-23, there is shown a nozzle 600 having segments 604 for retaining the torn casing of a collapsible tube within the nozzle 600 during dispensing to ensure unobstructed flow of viscous material through the nozzle's dispensing end. The nozzle 600 can be made of plastic, metal, composite, an alloy or any combination thereof. The nozzle is arranged for use for dispensing a viscous material from a collapsible tube (not shown). The nozzle 600 can include a body featuring a nozzle sidewall 608 having an interior surface 616 that defines an internal cavity 612, an external surface, a receiving end opening 624 configured to receive viscous material 628 from the collapsible tube, and a dispensing end opening 632 for depositing the viscous material onto a work surface. The dispensing end opening 632 may be circular or V-shaped as shown in FIG. 21. The nozzle 600 may include a tapered profile in which the receiving end opening 624 is wider than the dispensing end opening 632.

The nozzle 600 can include a piercing projection 636 having a piercing tip 652 provided to tear the thin film casing 656 of a collapsible tube to enable flow of viscous material therefrom. best illustrated in FIG. 21, the piercing projection 636 extends from the interior surface 616 of the nozzle 600. In the exemplary embodiment, one piercing projection 636 is shown; however, in alternative embodiments more than one piercing projection 636 may extend from the nozzle interior surface 616.

The nozzle 600 may also include a plurality of retention segments 604 projecting inwardly from the interior surface 616 of the nozzle 600 and located downstream from the piercing projections 636. The retention segments 604 may be spaced radially equidistantly from each other about the nozzle interior surface 616. FIG. 21 shows an exemplary embodiment that includes seven retention segments 604 spaced equidistantly from each other. A greater or fewer number of retention segments 604 may be included without departing from the scope of the invention. The retention segments 604 may be shaped to enable their securement to the nozzle interior surface 616 or may be integrally formed therewith. At its free end, each retention segment 604 is provided with a receiving surface 638 oriented perpendicular to the direction of flow of the viscous material, and a retention barb 640 extending obliquely in a direction opposite the direction of flow. The retention barbs 640 and receiving surfaces 638 are arranged to engage and retain therein the torn casing 656 to prevent the casing 656 from obstructing the dispensing end opening 632 during dispensing.

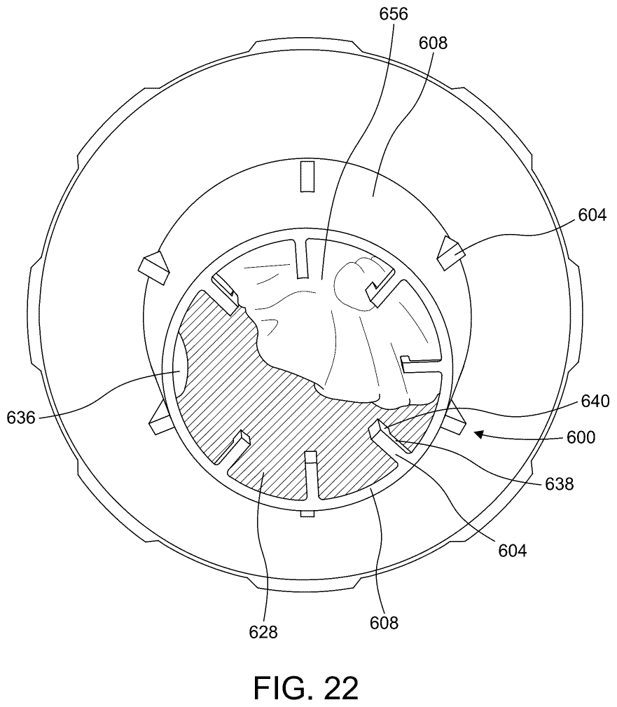

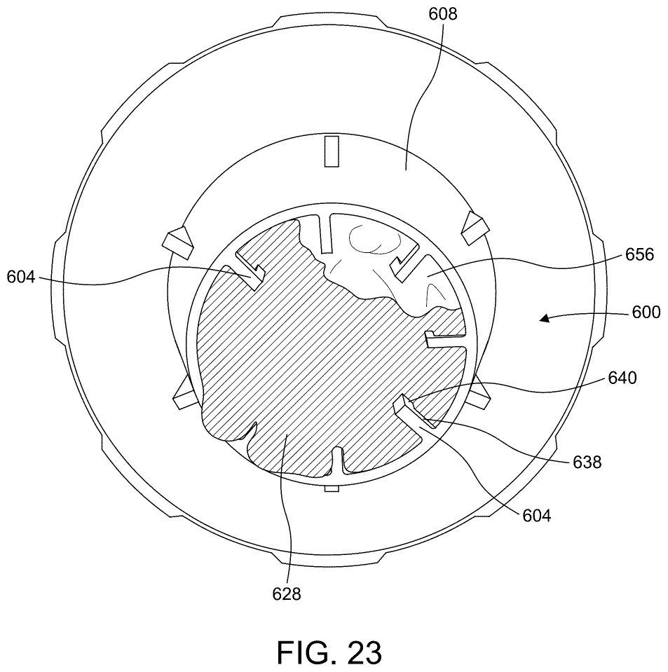

Referring now to FIGS. 22 and 23, as the collapsible tube is pressed against the piercing tip 652 of the piercing projection 636 in response to force applied by dispensing tool, the casing 656 at the front end of the collapsible tube is pierced to expel the viscous material 628 therefrom. In FIG. 22, an initial amount of viscous material 628 is shown being expelled from the collapsible tube and pushing the torn casing 656 towards the retention segments 604 where it is engaged and retained by the retention barbs 640 and receiving surfaces 638 to prevent it from obstructing the dispensing end opening 632. In FIG. 23, as the collapsible tube continues to be compressed, the piercing tip 652 continues to tear through the casing 656 and more viscous material 628 is expelled. As the viscous material 628 travels downstream through the nozzle 600, it continues to push the torn casing 656 downwardly towards the retention segments 604 where it is engaged and retained as described above. In this manner, the retention segments 604 prevent the torn casing 656 and any tie clip attached thereto from becoming lodged in or otherwise obstructing the dispensing end opening 632 during dispensing.

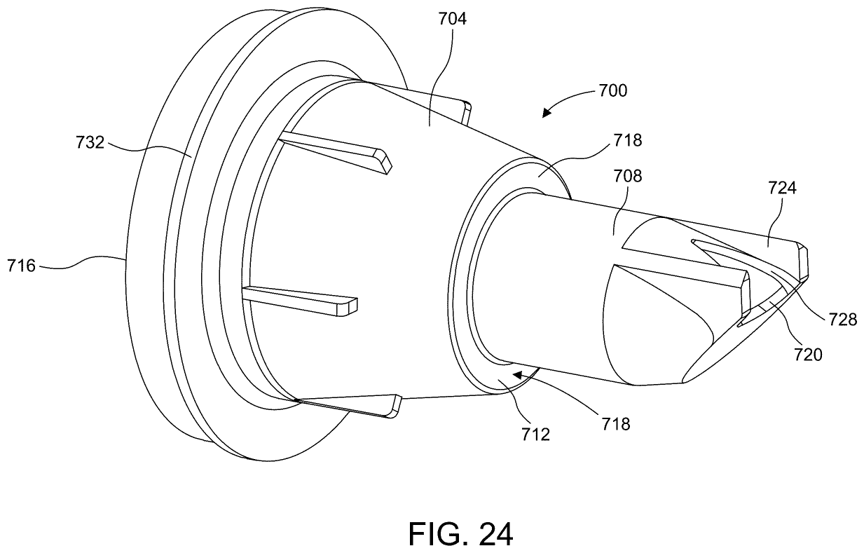

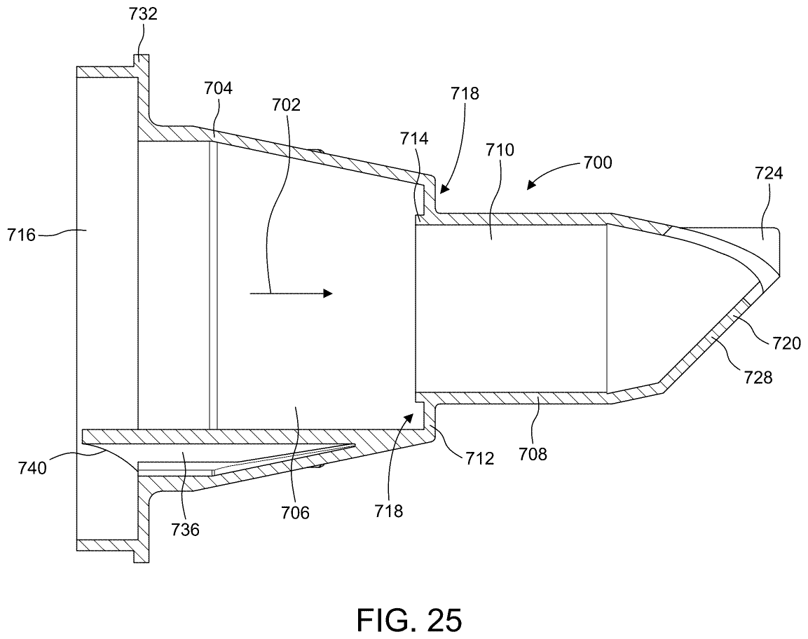

Referring now to FIGS. 24-26, there is shown a nozzle 700 having a retention structure 718 for retaining therein a torn collapsible tube (not shown) to ensure unobstructed flow of viscous material through the nozzle during dispensing. The nozzle 700 can be made of any suitable material, including those described in the above embodiments. The nozzle 700 may include a body featuring an upper sidewall 704 having an interior surface 706 and a lower sidewall 708 also having an interior surface 710. In the exemplary embodiment, the retention structure 718 is located within the nozzle 700 at a position located downstream (downstream direction arrow 702) from a piercing projection 736 that includes a piercing tip 740 to pierce and tear the thin film material of the collapsible tube. The retention structure 718 includes an annular floor 712 having a large central opening 713 configured to permit the free flow of viscous material therethrough during dispensing. The annular floor 712 may be oriented in a direction perpendicular to the direction of flow (arrow 702) of the viscous material. An annular inner wall 714 extends in an upstream direction (opposite arrow 702) from the central opening 713. The upper sidewall 704 extends from a receiving end opening 716 to the annular floor 712. Together, the upper sidewall 704, the annular floor 712, and the annular inner wall 714 form a retention structure 718 sized adequately to receive and retain therein the torn collapsible tube during dispensing without impeding the flow of viscous material through the nozzle 700. The lower sidewall 708 extends from the annular floor 712 to the dispensing end opening 720. As shown in FIG. 25, the annular inner wall 714 may be formed of a portion of the lower sidewall 708.

The receiving end opening 716 may be wider than the dispensing end opening 720. In an exemplary embodiment, the upper sidewall 704 may include a tapered profile and the lower sidewall 708 may include a generally cylindrical profile. The dispensing end opening 720 may include a generally circular aperture (not shown) and may include an inverted V-shaped notch 728 for dispensing a V-bead. In another embodiment, the dispensing end opening 720 may include a pair of stabilizing feet 724. The nozzle 700 may include an annular shoulder 732 to enable its retention within the barrel or carriage assembly of a dispensing tool.

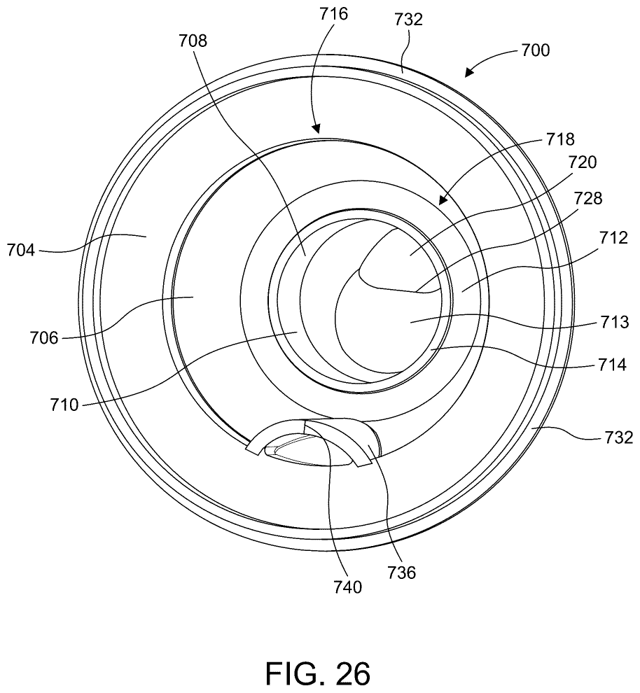

As best illustrated in FIGS. 25 and 26, the piercing projection 736 extends inwardly from the interior surface 706 of the upper sidewall 704. As the collapsible tube is pressed against the piercing tip 740 in response to force applied by dispensing tool, the collapsible tube is pierced and torn expelling viscous material therefrom. As the viscous material is expelled from the collapsible tube, it pushes the torn collapsible tube towards and into the retention structure 718 which catches and retains the torn collapsible tube (and any tie clip attached thereto) to prevent any flow obstruction at the dispensing end opening 720.

While the principles of the invention have been described above in connection with preferred embodiments, it is to be clearly understood that this description is made only by way of example and not as a limitation of the scope of the invention.

1. A nozzle for dispensing a viscous material from a collapsible tube positioned on a dispensing device, the collapsible tube formed of a thin wall casing, the dispensing device having a compression assembly arranged to compress the collapsible tube towards the nozzle, the nozzle comprising:
a. an interior surface, a receiving end opening, and a dispensing end opening, the nozzle arranged for being retained on the dispensing device adjacent the collapsible tube;
b. one or more piercing projections extending from the nozzle interior surface which upon compression of the collapsible tube is configured to pierce and tear the casing to release the viscous material contained therein; and,
c. a retention structure located within the nozzle at a position downstream from the one or more piercing projections, the retention structure including an annular floor having a central opening to permit free flow of the viscous material therethrough and an annular inner wall extending in an upstream direction from the central opening, the retention structure configured to receive and retain therein a torn casing to enable unobstructed flow of the viscous material through the dispensing end opening.

2. The nozzle of claim 1, wherein the nozzle additionally comprises an upper sidewall extending from the receiving end opening to the retention structure and forming an outer wall of the retention structure.

3. The nozzle of claim 2, wherein the nozzle additionally comprises a lower sidewall extending from the retention structure to the dispensing end opening, a portion of the lower sidewall forming the annular inner wall of the retention structure.

4. The nozzle of claim 3, wherein the upper sidewall includes a tapered profile, and the lower sidewall includes a generally cylindrical profile.

5. The nozzle of claim 1, wherein the annular floor is oriented in a direction perpendicular to the direction of flow of the viscous material through the nozzle.

6. The nozzle of claim 1, wherein each of the one or more piercing projections includes a piercing tip facing towards the receiving end opening.

7. The nozzle of claim 1, wherein the dispensing end opening is shaped to dispense a V-bead of the viscous material onto a substrate.

8. The nozzle of claim 1, additionally comprising stabilizing feet located on opposed sides of the dispensing end opening.

9. A nozzle for dispensing a viscous material from a collapsible tube positioned within a dispensing device, the collapsible tube formed of a thin wall casing, the dispensing device having a compression assembly arranged to compress the collapsible tube towards the nozzle, the nozzle comprising:
a. an interior surface, a receiving end opening, and a dispensing end opening, the nozzle arranged for being retained on the dispensing device adjacent the collapsible tube;
b. one or more piercing projections extending from the nozzle interior surface which upon compression of the collapsible tube is configured to pierce and tear the casing to release the viscous material contained therein; and,
c. a plurality of retention segments projecting inwardly from the interior surface and located at positions downstream from the one or more piercing projections, the plurality of retention segments configured to engage and retain therein a torn casing to enable unobstructed flow of the viscous material through the dispensing end.

10. The nozzle of claim 9, wherein each of the plurality of retention segments includes a retention barb and a receiving surface positioned on a free end thereof.

11. The nozzle of claim 10, wherein each retention barb extends obliquely into the nozzle cavity.

12. The nozzle of claim 9, wherein the plurality of retention segments is spaced equidistantly from one another on the nozzle interior surface.

13. The nozzle of claim 9, wherein the plurality of retention segments comprises seven retention segments.

14. The nozzle of claim 10, wherein each receiving surface is a flat surface oriented perpendicular to a direction of flow through the nozzle.

15. The nozzle of claim 9, wherein each of the one or more piercing projections includes a piercing tip facing towards the receiving end opening.

16. A kit for converting a device for dispensing viscous material from a cartridge to a device for dispensing viscous material from a collapsible tube, the dispensing device including a carriage assembly arranged for housing the cartridge when configured for dispensing from the cartridge, and a drive member for moving an ejector in a forward direction, the kit comprising:
a. a rigid sleeve having a tubular thin-walled body portion;
b. a piston ring sized for fitting over the ejector and having an outer periphery configured to abut an inner wall of the rigid sleeve to provide a seal with the inner wall; and,
c. wherein when the dispensing device is configured for dispensing from the collapsible tube, the collapsible tube and the piston ring are inserted into the rigid sleeve, the rigid sleeve is registered within the carriage assembly with the piston ring located between a rear end of the collapsible tube and the ejector, and the piston ring is fitted over the ejector to avoid pinching of the collapsible tube during dispensing.

17. The kit of claim 16, wherein the rigid sleeve is cylindrical.

18. The kit of claim 16, additionally comprising a nozzle attached to a front end of the collapsible tube by gluing.

19. The kit of claim 16, wherein the rigid sleeve is reusable.

20. The kit of claim 16, wherein a nozzle includes one or more piercing projections extending from the nozzle interior surface and a retention structure located within the nozzle at a position downstream from the one or more piercing projections.

21. The kit of claim 16, wherein the rigid sleeve is made of a transparent material.

22. A dispensing device for dispensing viscous material from a cartridge which is convertible to a device for dispensing viscous material from a collapsible tube, the dispensing device including a carriage assembly arranged for housing the cartridge when configured for dispensing from the cartridge, and a drive member for moving an ejector in a forward direction, wherein components for converting the dispensing device include a rigid sleeve having a tubular thin-walled body portion, and a piston ring sized for fitting over the ejector and having an outer periphery configured to abut an inner wall of the rigid sleeve to provide a seal with the inner wall, wherein when the dispensing device is configured for dispensing from the collapsible tube, the collapsible tube and the piston ring are inserted into the rigid sleeve, the rigid sleeve is registered within the carriage assembly with the piston ring located adjacent the ejector, and the piston is fitted over the ejector to avoid pinching of the collapsible tube during dispensing.
